(19) United States
(12) Patent Application Publication
(10) Pub. No.: US 2015/0351063 A1
(43) Pub. Date: Dec. 3, 2015

(54) SCH-LINKED RS CONFIGURATIONS FOR NEW CARRIER TYPE

(71) Applicants: Gilles CHARBIT, (US); Erlin ZENG, Beijing (CN); Na WEI, Beijing (CN)

(72) Inventors: Gilles CHARBIT, Farnborough (GB); Erlin ZENG, Beijing (CN); Na WEI, Beijing (CN)

(73) Assignee: BROADCOM CORPORATION, Irvine, CA (US)

(21) Appl. No.: 14/435,369

(22) PCT Filed: Oct. 12, 2012
(86) PCT No.: PCT/CN2012/082840

§ 371 Date: Apr. 13, 2015

(51) Int. Cl. H04W 56/00; H04W 72/04

(52) U.S. Cl. CPC H04W 56/0015; H04W 72/0446; H04W 84/042

(57) ABSTRACT

An apparatus and a method are provided, by which a reference signal to be used for channel estimation is sent (e.g., by a base station) or received (e.g., by a user equipment), wherein the reference signal is placed in one subframe in a group of consecutive subframes of a radio frame, the subframe being determined based on the cell identity.

### FIELD OF THE INVENTION

The present invention relates to methods, devices and computer program products for providing configurations for a reference signal, and in more detail for providing SCH-linked RS configurations for New Carrier Type.

### BACKGROUND

The following meanings for the abbreviations used in this specification apply:

### 3GPP 3^{rd} Generation Partnership Project

### AP Antenna Port

### CA Carrier Aggregation

CC Component carrier

### CoMP Coordinated Multipoint

### CP Cyclic Prefix

### CRS Common or Cell-specific Reference Signal

### CSI RS Channel State Information

### DM RS Demodulation Reference Signal

### DL Downlink

### eNB Enhanced Node B. Name for Node B in LTE

ePDCCH Enhanced Physical Downlink Control Channel

### FD Frequency Domain

### HetNet Heterogeneous Network

### LTE Long Term Evolution

### LTE-A Long Term Evolution Advanced

### MIB Master Information Block

### NCT New Carrier Type

### PCC Primary Cell Carrier

### PCell Primary Cell

### PCI Physical Cell Identifier

### PDCCH Physical Downlink Control Channel

### PRB Physical Resource Block

### PSS Primary Synchronization Signal

### RCRS Reduced Cell-specific Reference Signal

### RRC Radio Resource Control

### RRH Remote Radio Head

### RRM Radio Resource Management

### RRS Reduced Reference Signal

### RS Reference Signal

### RSRP Reference Signal Received Power

### SCC Secondary Cell Carrier

### SCell Secondary Cell

### SCH Synchronization Channel

### SI System Information

### SSS Secondary Synchronization Signal

### TD Time Domain

### TM9 Transmission Mode 9

### UE User Equipment

### UL Uplink

### WID Working Item Description

Embodiments of the present invention relate to LTE-Advance, for which 3GPP is working on the technical discussions and standardizations. In RAN#51 plenary, a new Rel-11 Carrier Aggregation (CA) enhancements WID was approved. This includes study NCT including non-backwards compatible elements (as described, e.g., in RP-1104551, “LTE CA enhancements WID”, RAN1#54, March 2011, and R1-100809, “Carrier types offline discussion”, Huawei, 3GPP RAN1 59bis).

In RAN1#68bis, it was agreed that at least for the unsynchronised case a so-called Reduced Cell-specific Reference Signal (RCRS) for NCT should be present. Properties of this new reference signal should be as follows:

The new carrier type can carry 1 RS port (consisting of the Rel-8 CRS Port 0 REs per PRB and Rel-8 sequence) within 1 subframe with 5 ms periodicity. This RS port is not used for demodulation.

It is for further study how RSRP measurements would then be handled for the NCT.

The RCRS is used for tracking. Its possible use for Radio Resource Management is for further discussions.

### SUMMARY

The present invention addresses such situation and aims to provide a configuration for a reference signal by which overhead and power consumption of a user equipment can be reduced and interference between reference signals on different cells can be avoided.

Various aspects of examples of the invention are set out in the claims.

According to a first aspect of the present invention, there is provided an apparatus comprising at least one processor, and at least one memory including computer program code, the at least one memory and the computer program being configured to, with the at least one processor, cause the apparatus to determine one subframe in a group of consecutive subframes of a radio frame in which a reference signal to be used for channel estimation is to be placed based on the cell identity, to place the reference signal in the determined subframe, and to send a reference signal.

According to a second aspect of the present invention, there is provided an apparatus comprising at least one processor, and at least one memory including computer program code, the at least one memory and the computer program being configured to, with the at least one processor, cause the apparatus to receive a reference signal to be used for channel estimation, and to perform channel estimation operations based on the reference signal, wherein the reference signal is placed in one subframe in a group of consecutive subframes of a radio frame, the subframe being determined based on the cell identity.

According to a third aspect of the present invention, there is provided a method comprising
determining one subframe in a group of consecutive subframes of a radio frame in which a reference signal to be used for channel estimation is to be placed based on the cell identity,
placing the reference signal in the determined subframe, and
sending the reference signal.

According to a fourth aspect of the present invention, there is provided a method comprising
receiving a reference signal to be used for channel estimation, and
performing channel estimation operations based on the reference signal.
wherein the reference signal is placed in one subframe in a group of consecutive subframes of a radio frame, the subframe being determined based on the cell identity.

Modifications of the above aspects are defined in the dependent claims.

According to a fifth aspect of the present invention, a computer program product comprising computer-executable components which, when executed on a computer, are configured to carry out the method as defined in any one of the third and fourth aspects and their modifications.

Thus, according to embodiments of the present invention, a sparse distribution of reference signals can be achieved, so that overhead and power consumption can be reduced. Furthermore, the position of the reference signal is determined based on the identity of the corresponding cell, so that interference between different cells can be avoided.

### BRIEF DESCRIPTION OF DRAWINGS

For a more complete understanding of example embodiments of the present invention, reference is now made to the following descriptions taken in connection with the accompanying drawings in which:

FIGS. 1A and 1B show a simplified structures of an eNB and a method carried out by an eNB according to embodiments of the present invention,

FIGS. 2A and 2B show simplified structures of a UE and a method carried out by a UE according to embodiments of the present invention,

FIG. 3 shows an example of RRS based on CSI-RS configuration 0 for 8 APs according to an embodiment of the present invention, and

FIG. 4 shows an example for network planning of RRH cells according to an embodiment of the present invention.

### DESCRIPTION OF EXEMPLARY EMBODIMENTS

Exemplary aspects of the invention will be described herein below.

It is to be noted that the following exemplary description refers to an environment of the LTE system (long term evolution) and/or local area networks thereof. However, it is to be understood that this serves for explanatory purposes only. Other systems differing from the LTE system can be adopted.

However, before explaining embodiments of the invention in detail, the problem underlying the present application is described by referring to heterogeneous network scenarios.

For example, in R1-121465, DoCoMo, “Views on DL RSs for Unsynchronized New Carrier”, 3GPP RAN1#68bis, a scenario referred to as Heterogenous Network (Hetnet) scenario A uses CRS-free Release-11 NCT for some pico/RRH cells on SCC for cell-range extension, while other pico/RRH cells use Release-10 carriers. Some solution will be needed to address the following issues:

A Rel-11 UE must simultaneously perform two types of mobility measurements, i.e., the existing CRS-based measurement and a new CSI-RS-based measurement.

In case RCRS is used for RRM measurements, there may be a need to co-ordinate inter-RCRS interference between SCells due to sparse RCRS.

Another example is described in R1-121018, Ericsson, “Main scenarios and use cases for additional carrier types”, 3GPP RAN1#68bis, a scenario referred to as HetNet scenario C uses CRS-free Release-11 NCT for pico cell on PCC and SCC for cell-range extension. The macro cell on PCC and SCC uses Release-10 carriers. In this scenario (scenario C), the CRS-free NCT is standalone—i.e. it is not aggregated with a release-10 carrier.

That is, in addition to the issues highlighted for HetNet scenario A, a new CSI-RS based RRM measurement or RCRS based RRM measurement for the PCell may also be needed. In the following, it is referred to the new CSI-RS signal as the Reduced Reference Signal (RRS).

In the following, time domain configuration of Reduced Reference Signals (RRS) within 5 ms is described.

In detail, in Rel-8, inter-CRS interference is limited by linking frequency parameters (ν and ν_{shift} define the position in the frequency domain) and the reference signal sequence for CRS to the cell ID N^{cell}_{ID} implicitly mapped to Synchronization Channel (SCH) (as described in 3GPP TS 36.211, “Physical Channels and Modulation”, v10.2.0, for example). The placement of CRS in time domain is fixed as happening every subframe.

In RCRS for NCT or in Reduced Reference Signal (RRS) based on CSI-RS for NCT, there may be a need for flexible time-domain configuration to increase orthogonality for improved inter-NCT interference mitigation. This will help tracking performance (based on RCRS) and RRM measurement accuracy/latency (based on RCRS or RRS). It seems problematic to configure RRS flexibly for UEs making initial cell access or UE in RRC idle making cell (re)-selection. RRS may be used for tracking and RRM measurements (especially, by UEs in RRC idle).

Assuming there is backhaul existence between the macro cell eNB PCell and the pico/RRH SCells in HetNet scenario A mentioned above, the minimum requirements for UE tracking synchronization algorithms is to cope with a relative propagation delay difference up to 31.3 μs (i.e. 1.3 μs timing offset due to BS time alignment and 30 μs additional propagation delay difference due to macro eNB and RRHs being not co-located) among the component carriers to be aggregated in inter-band non-contiguous CA (as described, e.g., in R2-113389, “CR 36.300 Release 10”, DoCoMo, RAN2#74, May 2011). For neighbouring SCells experiencing similar propagation delays, quasi perfect synchronization could be assumed (i.e. within a few μs). This seems worst case HetNet scenario. Scheduling the RRS in the same (fixed) subframes for all neighbouring SCells will lead to inter-SCell RRS interference, since orthogonality in frequency domain and sequence domain based on Rel-8 CRS seems limited.

No solution for providing a suitable configuration for RRS and/or RCRS as mentioned above is known yet.

In Rel-10, CSI-RS is specified in (3GPP TS 36.213 “Physical layer procedures”, v10.2.0 (2011-06), chapter 7.2.5) and is configured via dedicated signalling.

A straightforward solution would be to configure the RCRS via dedicated signaling on PCell. For example, in R1-122122, ZTE, “RS for Unsynchronised New Carrier Type and Transmission Mode”, 3GPP RAN1#69 [7], a subframe offset parameter (CRSsubframeoffset) configured by higher layers, describes the first subframe position carrying RCRS was proposed. By CRSsubframeoffset and information of 5 ms periodicity, series of subframe locations within a radio frame could be defined. CRSsubframeoffset ranges from {0, 1, 2, 3, 4} in FDD. When CRSsubframeoffset are configured to 0, RCRS are mapped to subframe #0 and #5 in a radio frame, and so on. For two adjacent cells, two different RCRS subframe is taken and interference from RCRS can be avoided. One obvious drawback of this solution is that it is not applicable to scenario C since we use standalone NCT (PCC or SCC). This solution could be considered for scenario A, but has the drawback that the macro eNB doesn't know which SCell the UE can best select. This way seems not efficient and probably not effective either. Assuming macro eNB knows location of UE with some accuracy (this requires some signalling and positioning technology supported by the network including eSLMC entity), there could be need to indicate the CRSsubframeoffset for at least 5 SCells. The UE will anyway need to detect these RCRS for each possible SCell blindly.

In case RRS is considered (with a relatively large number of RRS configurations, as would be outlined in the next section), there could be similarly quite a few RRS configurations to indicate to the UE via higher layer signalling. According to FCC requirements 98% UEs get position within 150 m accuracy. Assuming 100 m range of RRH, at least >7 RRS configurations would need to be indicated and blindly detected by the UE (for the remaining 2%, or assuming UE is moving with some velocity, then more RRS configurations may be needed). In case the list of RRS configurations is kept reasonably short to limit impact of signaling overhead on PCC, the right RSS configuration may not be indicated, and so UE may have to try blindly all possible RSS configurations as a fall back. This adds to complexity and false RRS detection could be an issue. Another drawback of this solution is that it cannot be used for UEs in RRC idle for cell re-selection using RRS-based RRM measurements, since dedicated signalling for these UEs is not possible (these UEs will need to go into RRC connected mode). Another solution that can be used for scenarios A and C without these drawbacks seems needed.

In R1-122517, Huawei, “Reduced-CRS transmission”, 3GPP RAN1#69, inter-cell interference protection of the RCRS based on using different subframe pairs in different cells was considered. In that way, RCRS collisions can be minimized even for frame synchronous systems. Another option is to position the RCRS in the vicinity of the PSS/SSS, e.g., in subframe pair (0,5). When the UE is processing the PSS/SSS in subframe 0 and 5, it would be buffering the received signal and additional buffering may be avoided for using the RCRS. There was no details on the mechanisms used for such pairing.

Embodiments addresses the above situations and provide apparatuses and methods by which configuration of a reference signal such as an RCRS and RRS can be achieved.

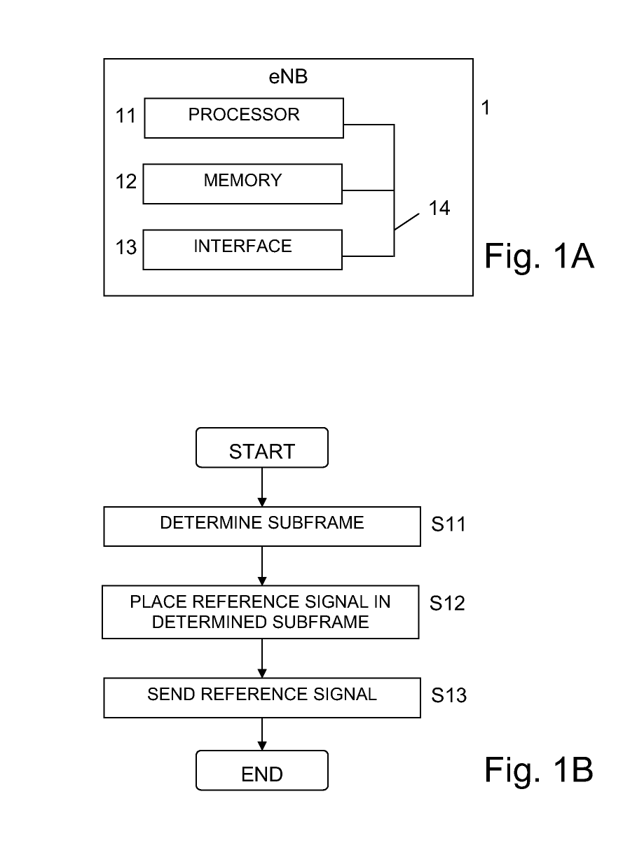

FIG. 1A illustrates a simplified block diagram of an eNB 1 as an example for a corresponding apparatus according to an embodiment of the present invention. It is noted that the corresponding apparatus according to the embodiment may consist only of parts of the eNB, so that the apparatus may be installed in an eNB, for example. Moreover, also the eNB is only an example and may be replaced by another suitable network element.

The eNB 1 according to this embodiment comprises a processor 11 and a memory 12. The memory comprises a computer program, wherein the memory 12 and the computer program are configured to, with the processor, cause the apparatus to determine one subframe in a group of consecutive subframes of a radio frame in which a reference signal to be used for channel estimation is to be placed based on the cell identity, to place the reference signal in the determined subframe, and to send a reference signal.

FIG. 1B shows a flow chart of a method as carried out by the eNB 1, for example. In step S11, the eNB determines the subframe in which the reference signal is to be placed based on the cell identity. In step S12, the eNB places the reference signal in the determined subframe, and in step S13, the eNB sends the reference signal.

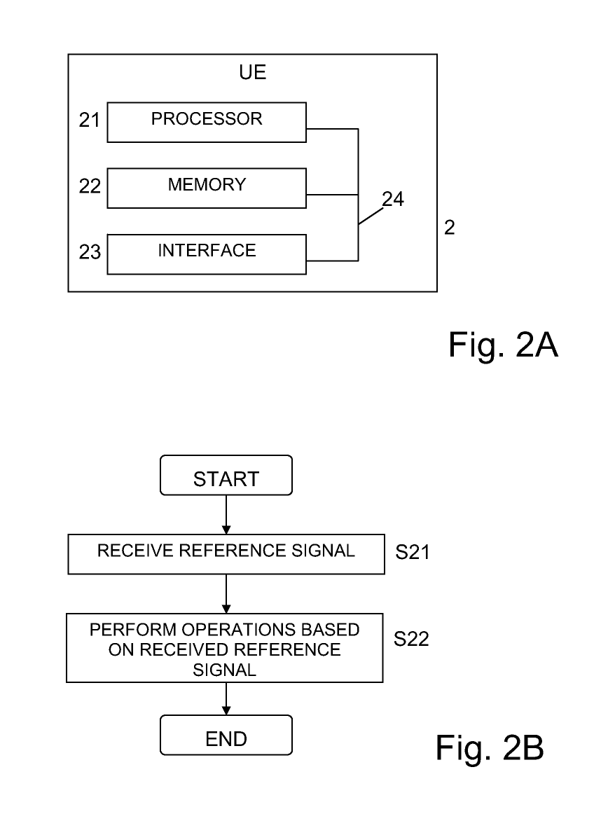

FIG. 2A illustrates a simplified block diagram of an UE 2 as an example for a corresponding apparatus according to an embodiment of the present invention. It is noted that the corresponding apparatus according to the embodiment may consist only of parts of the UE, so that the apparatus may be installed in an UE, for example. Moreover, also the UE is only an example and may be replaced by another suitable network element.

The UE 2 according to this embodiment comprises a processor 21 and a memory 22. The memory comprises a computer program, wherein the memory 22 and the computer program are configured to, with the processor 21, cause the apparatus to receive a reference signal to be used for channel estimation, and to perform channel estimation operations based on the reference signal, wherein the reference signal is placed in one subframe in a group of consecutive subframes of a radio frame, the subframe being determined based on the cell identity.

FIG. 2A shows a flow chart of a method as carried out by the UE 2, for example. In step S21, the UE receives the reference signal and in step S22, the UE performs operations based on the reference signal. These operations may include, for example, tracking time and frequency synchronization parameters based on the reference signal, and/or performing measurements based on the received reference signal.

Thus, according to this embodiment, a reference signal is transmitted (i.e., sent by the eNB and received or detected by the UE), wherein this reference signal is placed in a certain subframe in a group of consecutive subframes (e.g., half of a radioframe, so that the group includes five subframes), wherein the position is determined based on the identity of the cell.

Hence, no interference between neighbouring cell having different identities will occur.

Optionally, the eNB 1 and the UE 2 may also respectively comprise an interface 13 or 23 for providing connections to other network elements. Moreover, the processor 11 or 21, the memory 12 or 22, and the interface 13 or 23 may be respectively inter-connected by a suitable connection 14 or 24, e.g., a bus or the like. Moreover, it is noted that the apparatuses may comprise more than one processor, more than one memory and/or more than one interface, if this is suitable for a particular structure.

Examples for the reference signal to be used for channel estimation comprise synchronization channel linked reference signals such as RCRS, RRS and the like as will be described in the following in more detail.

As described in the following, according to some more detailed embodiments, solutions for configuration for the SCH-linked Reduced Cell-specific Reference Signal and configuration for the SCH-linked Reduced Reference Signal are outlined.

In the following, a more detailed embodiment for configuring RCRS is described.

N_{CRS-time}=5 RCRS time patterns for RCRS are defined. Further, the RCRS time pattern index, I_{CRS}, is defined where the I_{CRS} value indicates the RCRS placement within each half of a 10 ms radio frame as follows:

$${I}_{CRS} = {N}_{ID}^{NCTcell} mod 5 = \{ \begin{matrix}0 & for subframe \#0 , \#5 \\ 1 & for subframe \#1 , \#6 \\ 2 & for subframe \#2 , \#7 \\ 3 & for subframe \#3 , \#8 \\ 4 & for subframe \#4 , \#9\end{matrix}$$

In the above formula, it is defined: N^{NCT cell}_{ID}=3*N⁽¹⁾_{ID}+N⁽²⁾_{ID}, with PSS indicating N⁽²⁾_{ID} and SSS indicating N⁽¹⁾_{ID}, using Release 8 specifications.

Thus, the subframe of the subframes in the half of the radio frame, in which the reference signal is to be positioned, is determined based on the identity of the cell (N^{NCT cell}_{ID}) and the number of subframes in the half of the radio frame (which is 5 in this example).

The RCRS can be used by the UE to track the time and frequency synchronisation parameters, as agreed assumption in RAN1. In case RCRS cannot be used for RRM measurements, a new Reduced Reference Signal (RRS) may be considered, as further outlined below.

In the following, another detailed embodiment is described, according to which SCH-linked RRS time-frequency patterns are configured.

The RSS is based on the CSI-RS configurations for 8 Antenna Ports, which is described in 3GPP TS 36.211. The scheduling of RRS in neighbouring SCells is linked to the cell ID N^{cell}_{ID} implicitly mapped to Synchronization Channel (SCH). With adequate network planning, the inter-RRS interference between neighbouring cells can be mitigated by time-frequency-sequence orthogonality. The RRS re-use the N_{CSI-RS-config}=5 CSI-RS configurations for Normal CP for 8 Antenna Ports (AP) and 8 CSI-RS REs total. The PSS/SSS on SCH is implicitly linked to RRS configurations in
Frequency domain: The 8 CSI-RS REs are distributed between cells. This allows N_{freq}=4,2,1 RRS frequency patterns with N_{RRS-REs}=4, 2, 1 RRS REs respectively for 4, 2, 1 RRH cells.
Time domain: RRS subframe configuration parameters offset I_{CSI-RS}=0, . . . , 4 and periodicity T_{CSI-RS}=5 ms. This allows N_{RRs-time}=5 RRS time patterns.

There are N_{RRS-time-freq}=N_{CSI-RS-config}*N_{freq}*Nₜᵢₘₑ RRS time-frequency patterns per SCell assuming AP subset size, AP_{subset-size}≦8 and N_{RRS-REs} REs configured every 5 ms for tracking and may also be used for RRM measurements for implicit cell selection by UE in RRC idle.

N_{RRS-time-freq}=5*4*5=100 and N_{RRS-REs}2REs for AP_{subset-size}=2−{15,16},{17,18},{19,20},{21,22}

N_{RRS-time-freq}=5*2*5=50 and N_{RRS-REs}=4REs and AP_{subset-size}=4−{15,16,17,18},{19,20,21,22}

N_{RRS-time-freq}=5*1*5=25 and N_{RRS-REs}=8REs for AP_{subset-size}=8−{15,16,17,18,19,20,21,22}

In the following, mapping between a NCT PCI (physical cell identifier) and RRS time-frequency pattern is described.

Namely, PSS/SSS indicates the RRS time-frequency pattern in a cell with one-to-one mapping to new NCT PCI. As already mentioned above, it is defined: N^{NCTcell}_{ID}=3*N⁽¹⁾_{ID}+N⁽²⁾_{ID}, with PSS indicating N⁽²⁾_{ID} and SSS indicating N⁽¹⁾_{ID}.

As derivable from the following table, according to the present embodiment the possible number of NCT PCI is reduced compared to N^{NCTcell}_{ID}, (which has a maximum number of 504 according to Rel-8 specifications) by reducing the possible range for N⁽¹⁾_{ID}.

| | | AP subset | | Number of |
|---|---|---|---|---|
| N⁽²⁾_{ID} | N⁽¹⁾_{ID} | size | N_{RRS-REs} | NCT PCIs |
| 0, 1, 2 | 0, 1, . . . , 31 | 2 | 2 | 99 |
| 0, 1, 2 | 0, 1, . . . , 14 | 4 | 4 | 48 |
| 0, 1, 2 | 0, 1, . . . , 6 | 8 | 8 | 24 |

RRS can be used by the UE during (i) initial cell access, (ii) in RRC idle for cell selection, or (iii) in RRC connected state. The present embodiments of the invention provide a solution for (i) and (ii) since on NCT the RRS cannot be assumed to be scheduled in every subframe and UE-specific RS configuration (e.g. DM-RS and CSI-RS) via dedicated signaling can only take place after initial cell access by UE in connected state in the specifications.

In the following, a combination of the above SCH-linked RCRS and SCH-linked RSS is described.

In case of small bandwidth configuration (e.g. 1.4 MHz for low-cost Machine Type Communication of machines), tracking performance using RCRS may be challenging depending on level of interference experienced by the RCRS. The UE may use RCRS for the tracking, and also the RSS can be used for tracking, if scheduled. Tracking algorithm in the UE is not specified. Likewise, RRM measurements may use both the RCRS and RRS if scheduled. The two types of SCH-linked RS can readily be combined by using a new 2-bit field in Master Information Block or on a new System Information message or an existing system information message using some spare fields/bits—i.e.
SCH-linked-RS-type=00 NA
SCH-linked-RS-type=01 for SCH-linked RCRS only;
SCH-linked-RS-type=10 for SCH-linked RRS only;
SCH-linked-RS-type=11 for SCH-linked RCRS and SCH-linked RRS.

In the following, some examples for a technical implementation of the above embodiments are described.

First, determination of placement of RCRS within the radio frame is described.

As mentioned above, the UE can first detect the PSS/SSS on the NCT, which gives knowledge of the N^{NCTcell}_{ID}. The RCRS time schedule can then readily be known based on value of I_{CRS}. Assuming N^{NCT cell}_{ID} can indicate 504 SCC Physical Cell Identities based on Release 8 specifications, and using I_{CRS} formula above:
100 SCells will have RCRS scheduled in subframe #0, 101 SCells will have RCRS scheduled in subframe #1, 101 SCells will have RCRS scheduled in subframe #2, 101 SCells will have RCRS scheduled in subframe #3, and 101 SCells will have RCRS scheduled in subframe #4.
100 SCells will have RCRS scheduled in subframe #5, 101 SCells will have RCRS scheduled in subframe #6, 101 SCells will have RCRS scheduled in subframe #7, 101 SCells will have RCRS scheduled in subframe #8, and 101 SCells will have RCRS scheduled in subframe #9.

In the following, an example for mapping of RRS is described, based on CSI configuration 0, normal cyclic prefix, slot number nₛ=0.

There are N_{CSI-RS-config}=20, 10, 5 CSI-RS configurations for Normal CP for 2, 4, 8 APs and 2,4,8 CSI-RS REs respectively, in accordance with TS 36.211, Table 6.10.5.2-1.

There are 5 CSI-RS subframe configuration parameter offset values I_{CSI-RS}=0, . . . , 4 and periodicity T_{CSI-RS}=5 ms specified in TS 36.211, Table 6.10.5.3-1.

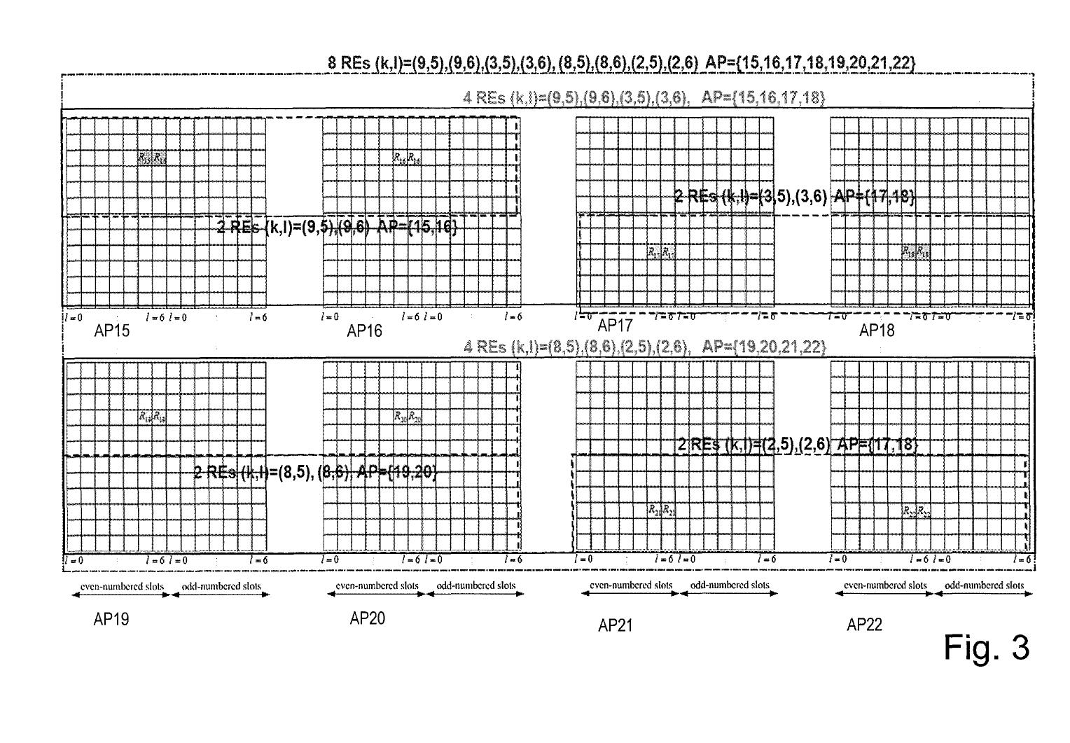

An example of RRS configuration for N_{RRS-REs} 2, 4, 8 REs for AP_{subset-size}=2, 4, 8 is illustrated in FIG. 3. The RRS is based on CSI-RS configuration 0, normal cyclic prefix, slot number nₛ=0, the frequency parameter k′, and the time parameter I′ as shown in the table below TS 36.211, Table 6.10.5.2-1.

| CSI | Number of CSI reference signals configured | | | | | |
|---|---|---|---|---|---|---|
| reference signal | 1 or 2 | | 4 | | 8 | |
| configuration | (k′, l′) | nₛ mod 2 | (k′, l′) | nₛ mod 2 | (k′, l′) | nₛ mod 2 |
| 0 | (9, 5) | 0 | (9, 5) | 0 | (9, 5) | 0 |

FIG. 3 shows the CSI configurations for eight antenna ports AP15 to AP22. With N_{RRS-REs}=2 REs for AP_{subset-size}=2 shown in by dashed lines in FIG. 3 (respectively enclosing two APs), there can be 4 SCells with orthogonal frequency RRS patterns. Since up to 5 CSI-RS subframe configuration parameter offset I_{CSI-RS}=0, . . . , 4 are possible, there can be up to 20=4*5 SCells with orthogonal time-frequency RRS patterns with N_{RRS-REs}=2 REs using CSI-RS configuration 0.

With N_{RRS-REs}=4 REs for AP_{subset-size}=4 shown by solid lines in FIG. 3 (respectively enclosing four APs), there can be 2 SCells with orthogonal frequency RRS patterns. Since up to 5 CSI-RS subframe configuration parameter offset I_{CSI-RS}=0, . . . , 4 are possible, there can be up to 10=2*5 SCells with orthogonal time-frequency RRS patterns with N_{RRS-REs}=4 REs using CSI-RS configuration 0.

With N_{RRS-REs}=8 REs for AP_{subset-size}=8 shown by dotted lines in FIG. 3 (enclosing all eight APs), there can be 1 SCell with orthogonal frequency RRS patterns. Since up to 5 CSI-RS subframe configuration parameter offset I_{CSI-RS}=0, . . . , 4 are possible, there can be up to 5=1*5 SCells with orthogonal time-frequency RRS patterns N_{RRS-REs}=8 REs using CSI-RS configuration 0.

Using the 5 available CSI-RS configurations for 8 APs, there can be 100, 50, and 25 SCells with orthogonal time-frequency RRS patterns for N_{RRS-REs}=2, 4, 8 REs for AP_{subset-size}=2, 4, 8 respectively.

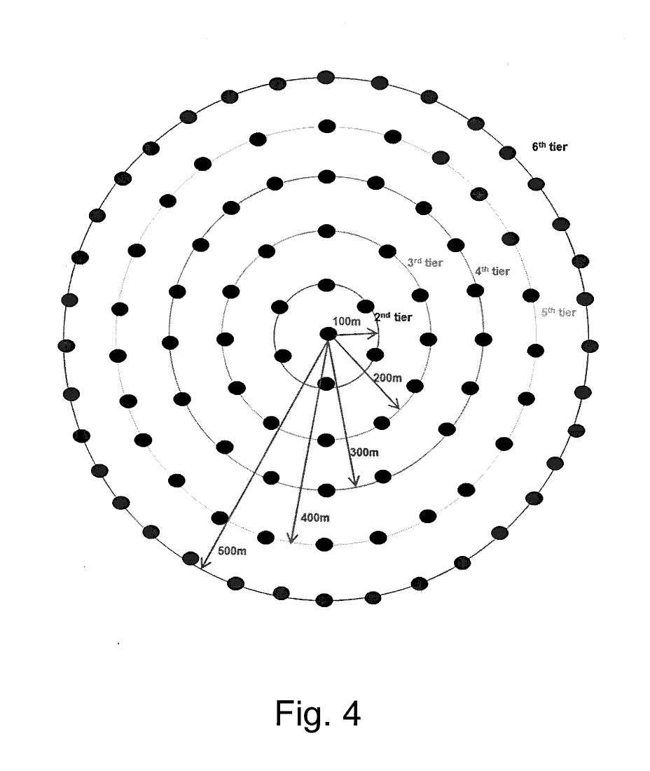

In the following, Inter-RRS interference mitigation in scenario C is described, by referring to FIG. 4 which illustrates an example for network planning of RRH cells, wherein a simplified arrangement of RRHs on different circular tiers are shown. In this example it is assumed that the RRHs on the first to fifth tiers all have different NCT PCIs, whereas on the sixth tier, RRHs with same NCT PCIs are arranged that may cause inter-RRS interference.

For RRS-based tracking, N_{RRS-REs}=4 REs per 5 ms and 48 NCT PCIs seems best compromise. If it is assumed that NCT cells are small with typically transmission power similar to HeNBs, could 48 NCT PCIs be sufficient? The network can use both PCI obtained from PSS/SSS detection and a unique mapping of PCI to the Cell Global ID to uniquely identify a cell in known case where a UE receives from two cells with identical PCI in conventional network. Assume that SCells are RRH cells with backhaul to macro eNB. Good network planning may readily minimize interference between SCells RRH cells by judicious geographical siting and ensures that RRH cell using same PCI are as far away as can be, as illustrated in FIG. 4—i.e. interference from far away RRH cells mainly on 5^{th} tier or higher tier assuming hexagonal network layout.

Moreover, a 100 meter transmission range, and no cell sectorisation (small one-sector RRH cell) are assumed. There are 1 RRH on 1^{st} tier, 6 RRHs on 2^{nd} tier at 100 m, 12 RRHs on 3^{rd} tier at 200 m, 18 RRHs on 4th tier at 300 m, 24 RRHs on 5^{th} tier at 400 m. This allows 48 RRHs with different NCT PCIs on 1^{st}-5^{th} tiers. RRHs with same PCI will be on 6^{th} tier at 500 m or higher tier (3 RRHs with same PCI on 6^{th} tier at 400 m).

For this example, inter-RRS interference mitigation in scenario A is considered as follows:

The use of cell sectorization and larger cells (e.g. cell radius of 1 km or 10 km) for standalone NCT may be more likely in this scenario. In case 3-cell sectorization is used, 48 RRHs with different NCT PCIs on 1^{st}-3rd tiers could be possible ((with 7 RRHs with same PCI on 3^{rd} tier at 2 km or 20 km). Assuming good antenna directivity for sectorized transmission, good network planning could ensure that inter-RRS interference free operations on 1^{st}-3^{rd} tier or possibly higher-tier could be achieved.

In the following, some further considerations of RRS are given.

Macro eNBs PCC or non-CA CC are on another frequency layer with Rel-8 CRS scheduled according to the specifications, where up to 504 PCIs can be available.

Rel-8 PSS/SSS and Rel-10 CSI-RS specifications can be re-used. No impact on legacy UEs since they can't access the NCT cell.

Rel-10 CSI-RS configuration via dedicated signalling for UE-specific configurations on NCT can be done—i.e. for CSI measurements for TM9.

SCH-linked RRS only uses one CSI RS configuration for tracking and RRM measurements for a given RRH cell, so 49 CSI RS configurations can be used for TM9 or maybe this CoMP for the SCell. Assuming 4 REs, there are 5*2*5 CSI RS configurations, and only 1/50 TD-FD CSI-RS resource are actually used by RRS.

PSS/SSS linked RRS seems too sparse for demodulation. The maximum of 8 Res per 5 ms means only TM1 possible, and loss of transmit diversity gain for MIB detection and ePDCCH in eCSS. With 4 Res or 2 Res, the loss may be more significant (even assuming low-mobility UEs). Note that this is assumption in RAN1′68bis that RCRS cannot be used for demodulation.

It is noted that the invention is not limited to the specific embodiments as described above.

For example, the values given above are only examples. In particular, according to some of the above embodiments, a reference signal is present in one subframe within a group of five subframes (i.e., one half of a radio frame). The invention is not limited to this case. Rather, the number of subframes can be arbitrarily chosen. For example, a whole radio frame including ten subframes can be selected.

Moreover, the information field in MIB described above is not limited to a two-bit field, and may have an arbitrary format. For example, the corresponding information may also be added to another existing information field, if suitable. Furthermore, if necessary, in the corresponding information field described above, also information regarding the use of more than two reference signals may be included.

Embodiments of the present invention may be implemented in software, hardware, application logic or a combination of software, hardware and application logic. The software, application logic and/or hardware generally, but not exclusively, may reside on the devices' modem module. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer or smart phone, or user equipment.

The present invention relates in particular but without limitation to mobile communications, for example to environments under LTE, WCDMA, WIMAX and WLAN and can advantageously be implemented in user equipments or smart phones, or personal computers connectable to such networks. That is, it can be implemented as/in chipsets to connected devices, and/or modems or other modules thereof.

If desired, at least some of different functions discussed herein may be performed in a different order and/or concurrently with each other. Furthermore, if desired, one or more of the above-described functions may be optional or may be combined.

As described above, according to exemplary embodiments of the present invention, an apparatus and a method are provided, by which a reference signal to be used for channel estimation is sent (e.g., by a base station) or received (e.g., by a user equipment), wherein the reference signal is placed in one subframe in a group of consecutive subframes of a radio frame, the subframe being determined based on the cell identity.

According to another aspect of embodiments of the present invention, an apparatus is provided which comprises
means for determining one subframe in a group of consecutive subframes of a radio frame in which a reference signal to be used for channel estimation is to be placed based on the cell identity,
means for placing the reference signal in the determined subframe, and
means for sending the reference signal.

According to a further aspect of embodiments of the present invention, an apparatus is provided which comprises
means for receiving a reference signal to be used for channel estimation, and
means for performing channel estimation operations based on the reference signal,
wherein the reference signal is placed in one subframe in a group of consecutive subframes of a radio frame, the subframe being determined based on the cell identity.

It is to be understood that any of the above modifications can be applied singly or in combination to the respective aspects and/or embodiments to which they refer, unless they are explicitly stated as excluding alternatives.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

1. An apparatus comprising
at least one processor, and
at least one memory including computer program code,
the at least one memory and the computer program being configured to, with the at least one processor, cause the apparatus
to determine one subframe in a group of consecutive subframes of a radio frame in which a reference signal to be used for channel estimation is to be placed based on the cell identity,
to place the reference signal in the determined subframe, and
to send a reference signal.

2. The apparatus according to claim 1, wherein the group of consecutive subframes is half of the radio frame.

3. The apparatus according to claim 1, wherein the at least one memory and the computer program are configured to, with the at least one processor, cause the apparatus to determine the one subframe in the group of consecutive subframes by performing a modulo operation on the cell identity by the number of subframes in the group of subframes.

4. The apparatus according to claim 1, wherein the reference signal is a synchronization channel linked reference signal.

5. The apparatus according to claim 4, wherein the reference signal is a channel state information reference signal, and a resource element on which the reference signal is transmitted within a resource block of the subframe is determined based on a preconfigured scheme, or
the reference signal is a cell-specific reference signal.

6. The apparatus according to claim 1, wherein reference signals are transmitted on a plurality of cells, and the at least one memory and the computer program are configured to, with the at least one processor, cause the apparatus to distribute the positions of the resource elements for the reference signals between the cells.

7. The apparatus according to claim 1, wherein the at least one memory and the computer program are configured to, with the at least one processor, cause the apparatus to indicate the use of the reference signal in system information.

8. The apparatus according to claim 7, wherein at least two different kinds of reference signals are transmittable, and the system information indicates the use of the reference signals.

9. The apparatus according to claim 7, wherein the system information is included in a field in a master information block and/or in a system information message.

10. The apparatus according to claim 1, wherein the apparatus is or is part of a base station.

11. An apparatus comprising
at least one processor, and
at least one memory including computer program code,
the at least one memory and the computer program being configured to, with the at least one processor, cause the apparatus
to receive a reference signal to be used for channel estimation, and
to perform channel estimation operations based on the reference signal,
wherein the reference signal is placed in one subframe in a group of consecutive subframes of a radio frame, the subframe being determined based on the cell identity.

12-21. (canceled)

22. A method comprising
determining one subframe in a group of consecutive subframes of a radio frame in which a reference signal to be used for channel estimation is to be placed based on the cell identity,
placing the reference signal in the determined subframe, and
sending the reference signal.

23. The method according to claim 22, wherein the group of consecutive subframes is half of the radio frame.

24. The method according to claim 22, further comprising determining the one subframe in the group of consecutive subframes by performing a modulo operation on the cell identity by the number of subframes in the group of subframes.

25. The method according to claim 22, wherein the reference signal is a synchronization channel linked reference signal.

26. The method according to claim 25, wherein
the reference signal is a channel state information reference signal, and a resource element on which the reference signal is transmitted within a resource block of the subframe is determined based on a preconfigured scheme, or
the reference signal is a cell-specific reference signal.

27. The method according to claim 22, wherein reference signals are transmitted on a plurality of cells, the method further comprising distributing the positions of the resource elements for the reference signals between the cells.

28. The method according to claim 22, further comprising indicating the use of the reference signal in system information.

29. The method according to claim 28, wherein at least two different kinds of reference signals are transmittable, and the system information indicates the use of the reference signals.

30. The method according to claim 28, wherein the system information is included in a field in a master information block and/or in a system information message.

31-43. (canceled)
